(19) United States
(12) Patent Application Publication
(10) Pub. No.: US 2024/0387853 A1
(43) Pub. Date: Nov. 21, 2024

(54) RECHARGEABLE BATTERY AND POUCH FORMING DEVICE THEREOF

(71) Applicant: SAMSUNG SDI CO., LTD., Yongin-si (KR)

(72) Inventors: Jinhwan KIM, Yongin-si (KR); Chihoon SONG, Yongin-si (KR)

(21) Appl. No.: 18/380,785

(22) Filed: Oct. 17, 2023

(30) Foreign Application Priority Data
May 16, 2023 (KR) 10-2023-0063412

(51) Int. Cl. H01M 10/04; H01M 50/105; H01M 50/131

(52) U.S. Cl. CPC H01M 10/0409; H01M 50/105; H01M 50/131

(57) ABSTRACT

A rechargeable battery pouch forming device, including a die supporting a first surface of a pouch base material to form the pouch base material for a rechargeable battery having a first opening, a stripper holding a second surface of the pouch base material supported on the die having a second opening larger than the first opening, and a punch that descends from the second surface side of the pouch base material through the second opening and the first opening to form a pouch by forming the pouch base material, the punch including a first round at a first corner of a first direction to form a vertex area, a second round at a second corner of a second direction crossing the first direction, a third round at a third corner of a third direction crossing the second direction.

### CROSS-REFERENCE TO RELATED APPLICATION

Korean Patent Application No. 10-2023-0063412 filed in the Korean Intellectual Property Office on May 16, 2023, is incorporated herein by reference in its entirety.

### BACKGROUND

### 1. Field

A rechargeable battery and a pouch forming device thereof is disclosed.

### 2. Description of the Related Art

Rechargeable batteries are batteries which can be charged and discharged, unlike primary batteries. Low-capacity rechargeable batteries are used for small, portable electronics such as mobile phones, laptop computers, or camcorders, and large-capacity rechargeable batteries are widely used for power sources for driving motors of electric bicycles, scooters, electric vehicles, forklifts.

### SUMMARY

Embodiments are directed to a rechargeable battery pouch forming device, including a die supporting a first surface of a pouch base material to form the pouch base material for a rechargeable battery having a first opening, a stripper holding a second surface of the pouch base material supported on the die having a second opening larger than the first opening, and a punch that descends from the second surface side of the pouch base material through the second opening and the first opening to form a pouch by forming the pouch base material, the punch including a first round at a first corner of a first direction to form a vertex area a second round at a second corner of a second direction crossing the first direction a third round at a third corner of a third direction crossing the second direction a first corner round curvedly shaped and at a first side corner corresponding to the first round in a diagonal direction of the first corner to form the vertex area a second corner round curvedly shaped and at a second side corner corresponding to the second round in a diagonal direction of the second corner, and a third corner round curvedly shaped and at a bottom corner corresponding to the third round in a diagonal direction of the third corner, the vertex area including a first three dimensional round connecting the center of the first corner round in three dimensions at the center of the first round a second three dimensional round connecting the center of the second corner round in three dimensions at the center of the second round, and a third three dimensional round connecting the center of the third corner round in three dimensions at the center of the third round.

The rechargeable battery pouch forming device may include a first curvature radius of the first corner round, a second curvature radius of the second corner round, and a third curvature radius of the third corner round are larger than a fourth curvature radius of a first corner round, a fifth curvature radius of a second corner round, and a sixth curvature radius of a third corner round of the punch for an electrode assembly of a winding type to accommodate an electrode assembly of a stack type.

The rechargeable battery pouch forming device may include the die has a long corner and a short corner that intersect corresponding to the first round and the second round of the punch at the second opening, the long corner corresponds to the first corner of the punch and forms a first die round greater than the first round, and the short corner corresponds to the second corner of the punch and forms a second die round greater than the second round.

The rechargeable battery pouch forming device may include a first length of the first corner round and a second length of the second corner round are the same size, and a third length of the third corner round is larger than the first length of the first corner round and the second length of the second corner round.

The rechargeable battery pouch forming device may include a first curvature radius of the first corner round and a second curvature radius of the second corner round are the same size, and a third curvature radius of the third corner round is larger than the first curvature radius of the first corner round and the second curvature radius of the second corner round.

The rechargeable battery pouch forming device may include a first length of the first round is greater than a second length of the first corner round, a third length of the second round is greater than a fourth length of the second corner round, and a fifth length of the third round is greater than a sixth length of the third corner round.

The rechargeable battery pouch forming device may include a first length of the first corner round and a second length of the second corner round are the same size, and a third length of the third corner round is smaller than the first length of the first corner round and the second length of the second corner round.

The rechargeable battery pouch forming device may include a first curvature radius of the first corner round and a second curvature radius of the second corner round are the same size, and a third curvature radius of the third corner round is smaller than the first curvature radius of the first corner round and the second curvature radius of the second corner round.

The rechargeable battery pouch forming device may include a first length of the first round is smaller than a second length of the first corner round, a third length of the second round is less than a fourth length of the second corner round, and a fifth length of the third round is smaller than a sixth length of the third corner round.

The rechargeable battery pouch forming device may include a first curvature radius of the first die round having the same size as a second curvature radius of the second die round.

The rechargeable battery pouch forming device may include the first curvature radius of the first die round, the second curvature radius of the second die round, and a third curvature radius of a third die round corresponding to the third round are larger than a fourth curvature radius of the first round, a fifth curvature radius of the second round, and a sixth curvature radius of the third round, respectively.

Embodiments are directed to a rechargeable battery, including a pouch including an outer flange provided on an outside and a forming part within the outer flange, and a stack type electrode assembly accommodated in the forming part, the forming part including side walls connected to the outer flange, a bottom connected to the side walls with a corner, first round at a first corner of a second direction to form a vertex area in the forming part, a second round at a second corner of a first direction crossing the second direction, and a third round at a third corner of a third direction crossing the first direction, a first corner round curvedly shaped and at the first side wall corner corresponding to the first round in a diagonal direction of the first corner to form the vertex area, a second corner round curvedly shaped and at the second side wall corner corresponding to the second round in a diagonal direction of the second corner, and a third corner round curvedly shaped and at the bottom corner corresponding to the third round in a diagonal direction of the third corner, the vertex area including a first round connecting the center of the first corner round in a three dimensional type at the center of the first round, a second three dimensional round connecting the center of the second corner round in a three dimensional type at the center of the second round, and a third three dimensional round connecting the center of the third round at the center of the third corner round in a three dimensional type.

The rechargeable battery may include a first curvature radius of the first corner round, a second curvature radius of the second corner round, and a third curvature radius of the third corner round are larger than a fourth curvature radius of a first corner round, a fifth curvature radius of a second corner round, and a sixth curvature radius of a third corner round of a pouch accommodating an electrode assembly of a winding type to accommodate an electrode assembly of a stack type.

The rechargeable battery may include a first length of the first corner round and a second length of the second corner round being the same size, and a third length of the third corner round being larger than the first length of the first corner round and the second length of the second corner round.

The rechargeable battery may include a first curvature radius of the first corner round and a second curvature radius of the second corner round are the same size, and a third curvature radius of the third corner round is larger than the first curvature radius of the first corner round and the second curvature radius of the second corner round.

The rechargeable battery may include a first length of the first round is greater than a second length of the first corner round, a third length of the second round is greater than a fourth length of the second corner round, and a fifth length of the third round is larger than a sixth length of the third corner round.

The rechargeable battery may include a first length of the first corner round and a second length of the second corner round are the same size, a third length of the third corner round is smaller than the first length of the first corner round and the second length of the second corner round.

The rechargeable battery may include a first curvature radius of the first corner round and a second curvature radius of the second corner round are the same size, and a third curvature radius of the third corner round is smaller than the first curvature radius of the first corner round and the second curvature radius of the second corner round.

The rechargeable battery may include a first length of the first round is smaller than a second length of the first corner round, a third length of the second round is smaller than a fourth length of the second corner round, and a fifth length of the third round is smaller than a sixth length of the third corner round.

Embodiments are directed to a rechargeable battery pouch forming device, including a die supporting a first surface of a pouch base material to form the pouch base material for a rechargeable battery having a first opening, a stripper holding a second surface of the pouch base material supported on the die having a second opening larger than the first opening, and a punch that descends from the second surface side of the pouch base material through the second opening and the first opening to form a pouch by forming the pouch base material, the punch including a first round formed at a first corner of a first direction to form a vertex area, a second round formed at a second corner of a second direction crossing the first direction, a third round formed at a third corner of a third direction crossing the second direction, a first corner round curvedly shaped and at a first side corner corresponding to the first round in a diagonal direction of the first corner to form the vertex area, a second corner round curvedly shaped and at a second side corner corresponding to the second round in a diagonal direction of the second corner, and a third corner round curvedly shaped and at a bottom corner corresponding to the third round in a diagonal direction of the third corner.

### BRIEF DESCRIPTION OF THE DRAWINGS

Features will become apparent to those of skill in the art by describing in detail exemplary embodiments with reference to the attached drawings in which:

FIG. 1 is a schematic diagram showing a pouch forming device.

FIG. 2 is an inverted perspective view showing a reversed punch applied to FIG. 1.

FIG. 3 is a perspective view showing one vertex area in a punch of FIG. 2.

FIG. 4 is a perspective view showing a vertex area of an example embodiment.

FIG. 5 is a top plan view showing spatial sizes for a vertex area of FIG. 3.

FIG. 6 is an inverted perspective view showing a reversed punch applied to a pouch forming device.

FIG. 7 is a perspective view showing one vertex area in a punch of FIG. 6.

FIG. 8 is a top plan view showing space sizes for a vertex area in FIG. 7.

FIG. 9 is a perspective view showing a die applied to FIG. 1.

FIG. 10 is a perspective view showing a rechargeable battery.

FIG. 11 is an exploded perspective view showing a rechargeable battery of FIG. 10.

FIG. 12 is a perspective view showing one vertex area of a pouch.

FIG. 13 is a perspective view showing another vertex area of a pouch.

FIG. 14 is a perspective view showing another vertex area of a pouch.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

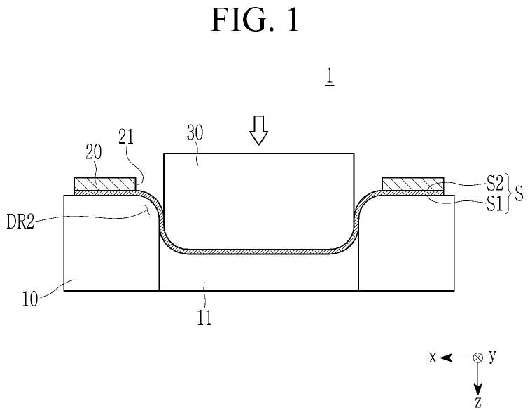

FIG. 1 is a schematic diagram showing a pouch forming device. Referring to FIG. 1, a pouch forming device 1 according to a first embodiment may include a die 10, a stripper 20, and a punch 30. The die 10 may support the first surface S1 of a pouch base material S to form a pouch by forming a pouch base material S for the rechargeable battery and may form a first opening 11.

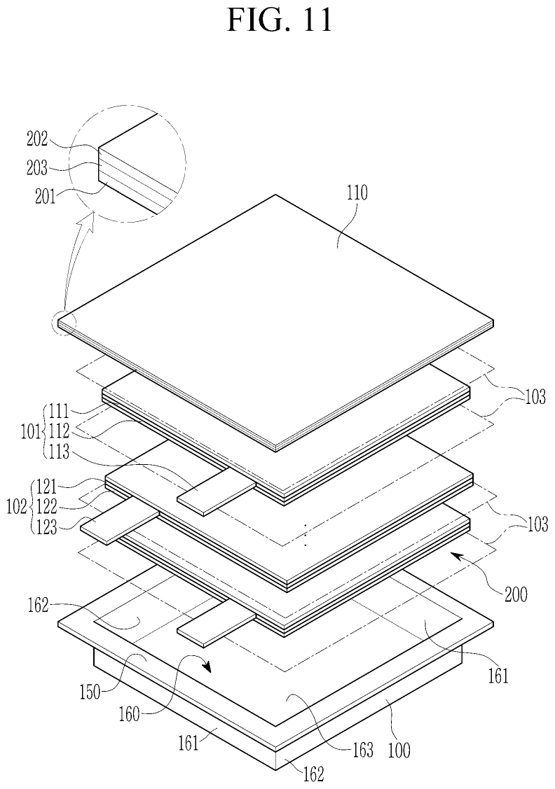

The stripper 20 may hold the second surface S2 of the pouch base material S supported to the die 10 and may have a second opening 21 that is larger than the first opening 11 and concentric. As an example, the lower surface of the pouch base material S is referred to as a first surface S1, and the upper surface is referred to as a second surface S2. The punch 30 may descend from the side of the second surface S2 of the pouch base material S through the second opening 21 to the inside of the first opening 11 to form the pouch base material S within the first opening 11 of the die 10. In this way, the pouch 100 may be formed (referring to FIG. 11).

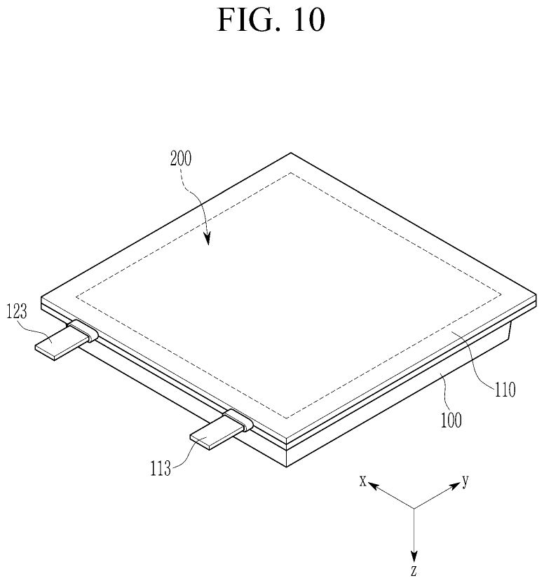

FIG. 11 is an exploded perspective view of a rechargeable battery of FIG. 10. Referring to FIG. 11, the pouch 100 may include an outer flange 150 provided on the outside and a forming part 160 formed by a forming within the outer flange 150. The pouch 100 may include a stack type electrode assembly 200 accommodated in the forming part 160. The forming part 160 may be connected to the outer flange 150 and may include first and second side walls 161 and 162 connected into a corner to each other and a bottom 163 connected to the first and second side walls 161 and 162 with a corner.

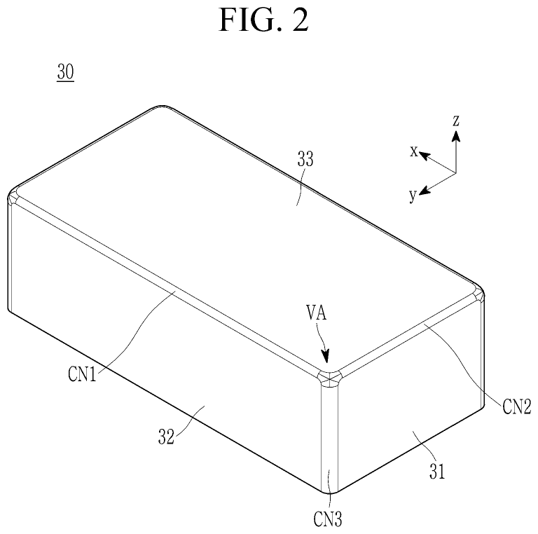

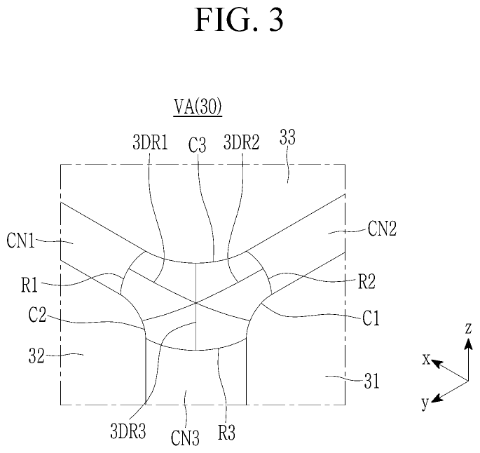

FIG. 2 is an inverted perspective view showing a reversed punch applied to FIG. 1. FIG. 3 is a perspective view showing one vertex area in a punch of FIG. 2. Referring to FIG. 2 and FIG. 3, the punch 30 may be used for the forming of the pouch that accommodates a stack type electrode assembly.

The punch 30, to form the forming part 160 of the pouch 100, may include first and second side surfaces 31 and 32, and a bottom 33 connected to the first and second side surfaces 31 and 32 with the corner. A vertex area VA may be formed at a portion where the first and second side walls 31 and 32 and the bottom 33 are connected. Therefore, the punch 30 may include four vertex areas VA.

The punch 30 may include a first round R1, a second round R2, and a third round R3 to form one vertex area VA. The first round R1 may be convex to the first corner CN1 extended in the first direction (an x-axis direction). The second round R2 may be convex to the second corner CN2 extended in a second direction (a y-axis direction) crossing the first direction. The third round R3 may be convexly formed to the third corner CN3 extending in a third direction (a z-axis direction) crossing the second direction.

Also, the punch 30 may include a first corner round C1, a second corner round C2, and a third corner round C3 to form one vertex area VA. The first corner round C1 may be formed as a round on the first side surface 31 corner corresponding to the first corner R1 in the diagonal direction of the first corner CN1. The second corner round C2 may be formed as a round on the 32 corner of the second side surface corresponding to the second corner CN2 in the diagonal direction of the second round R2. The third corner round C3 may be formed as a round at the bottom 33 corner corresponding to the third corner R3 in the diagonal direction of the third corner CN3.

In addition, the punch 30 may include a first 3D round 3DR1, a second 3D round 3DR2, and a third 3D round 3DR3 to form one vertex area VA. The first 3D round 3DR1 may connect the center of the first corner round C1 from the center of the first round R1 in a convex 3D way. The second 3D round 3DR2 may connect the center of the second corner round C2 from the center of the second round R2 in a convex 3D way. The third 3D round 3DR3 may connect the center of the third corner round C3 in a convex 3D way from the center of the third round R3.

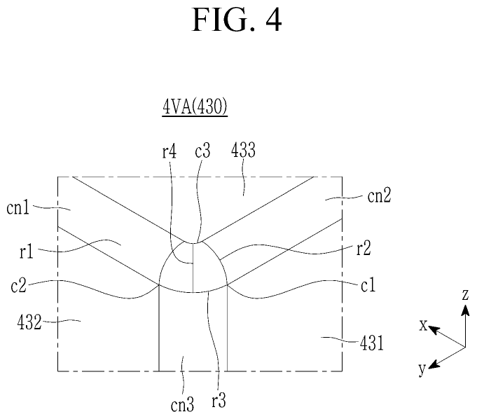

FIG. 4 is a perspective view showing a vertex area of an example embodiment. Referring to FIG. 4, a punch 430 may be used for forming a pouch that accommodates a winding type electrode assembly.

The punch 430 may include a first round r1, a second round r2, a third round r3, and a fourth round r4 to form one vertex area 4VA. The first round r1 may be convex to the first corner cn1 in the first direction (the x-axis direction). The second round r2 may be convex to the second corner cn2 of the second direction (the y axis direction) intersecting the first direction. The third round r3 may be convexly formed to the third corner cn3 of the third direction (the z-axis direction) intersecting the second direction. The fourth round r4 may be convexly formed between the first round r1 and the second round r2, and may be set with the same size as the first round r1 and the second round r2.

Also, the punch 430 may include a first corner angle c1, a second corner angle c2, and a third corner round c3 to form one vertex area 4VA. The first corner angle c1 may be formed perpendicular to the first side surface 431 corner corresponding to the first corner cn1 in the diagonal direction of the first round r1. The second corner angle c2 may be formed perpendicular to the second side surface 432 corner corresponding to the second corner cn2 in the diagonal direction of the second round r2. The third corner round c3 may be formed as a round at the bottom 433 corner corresponding to the third round r3 in the diagonal direction of the third corner cn3.

Again, referring to FIG. 3 to FIG. 5, in the punch 30 of the first embodiment, the curvature radius of the first corner round C1, the curvature radius of the second corner round C2, and the curvature radius of the third corner round C3 may be formed larger than each curvature radius corresponding to the first corner round c1, the second corner round c2, and the third corner round c3 in a punch (340, referring to FIG. 4) (C1>c1, C2>c2, C3>c3).

In the punch 30, the length of the first corner round C1 and the length of the second corner round C2 may be the same size (C1=C2). The length of the third corner round C3 may be larger than the length of the first corner round C1 and the length of the second corner round C2 (C3>C1=C2).

Also, in the punch 30, the curvature radius of the first corner round C1 and the curvature radius of the second corner round C2 may be the same size (C1=C2). The curvature radius of the third corner round C3 may be larger than the curvature radius of the first corner round C1 and the curvature radius of the second corner round C2 (C3>C1=C2). For convenience, no separate reference numeral is given for the length and the curvature radius.

Also, in the punch 30, the length of the first round R1 may be larger than the length of the first corner round C1 (R1>C1). The length of second round R2 may be larger than the length of second corner round C2 (R2>C2). The length of the third round R3 may be larger than the length of the third corner round C3 (R3>C3).

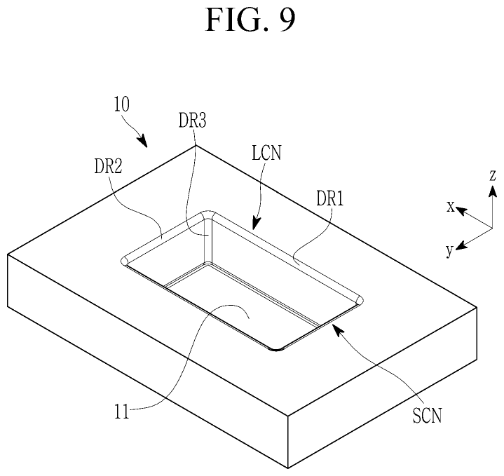

FIG. 9 is a perspective view showing a die applied to FIG. 1. Referring to FIG. 1 to FIG. 4 and FIG. 9, the die 10 may have long corners LCN and short corners SCN that intersect corresponding to the first round R1 and second round R2 of the punch 30 and may be formed in a convex shape at the first opening 11.

The long corner LCN may correspond to the first corner CN1 of the punch 30 and may form a first die round DR1 larger than the first round R1. The short corner SCN may correspond to the second corner CN2 of the punch 30 and may form a second die round DR2 larger than the second round R2. Also, the long and short corners LCN and SCN and the first and second corners CN1 and CN2 may be appropriately matched according to the size relationship between the die 10 and the punch 30.

The first die round DR1 and the second die round DR2 may improve a moldability by flexibly supporting the side walls 161 and 162 of the pouch 100 when forming the pouch base material S into the pouch 100 through the punch 30, thereby effectively securing the thickness of aluminum at the corner that connects the side walls 161 and 162, and the bottom 163 to the first, second, and third corners CN1, CN2, and CN3 of the punch 30.

As an example, the curvature radius of the first die round DR1 may be the same size as the curvature radius of the second die round DR2. The same thickness of aluminum or aluminum sheet may be secured at the corner connecting the side walls 161 and 162 and the bottom 163 of the formed pouch 100.

In addition, the die 10 may further include a third die round DR3 corresponding to the third round R3 of the punch 30. The curvature radius of the first die round DR1, the curvature radius of the second die round DR2, and the curvature radius of the third die round DR3 may be formed larger than the curvature radius of the first round R1, the curvature radius of the second round R2, and the curvature radius of the third round R3, which are defined by the punch 30, respectively. During the forming, the ascending and descending of the punch 30 may be stably guided.

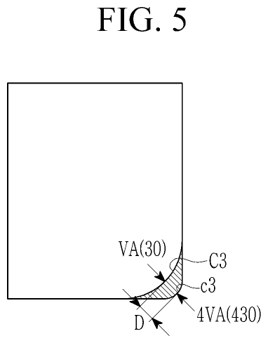

FIG. 5 is a top plan view showing spatial sizes for a vertex area of FIG. 3. Referring to FIG. 3 to FIG. 5, the punch 30 of the first embodiment may have the first round R1 of 1.0 mm, the second round R2 of 1.0 mm, the third round R3 of 1.5 mm, and may include a first 3D round 3DR1, a second 3D round 3DR2, and a third 3D round 3DR3. The punch 430 may have the first round r1 of 1.0 mm, the second round r2 of 1.0 mm, the third round r3 of 1.5 mm, and the fourth round r4 of 1.0 mm.

At this time, a difference D of 0.10 mm may occur in the vertex areas VA and 4VA of the punches 30 and 430. In this regard, compared to the vertex area 4VA of the punch 430 the vertex area VA of the punch 30 of the first embodiment may secure a larger remaining thickness of the aluminum or aluminum sheet of the pouch 100, so cracks may be further prevented, and the formability may be further improved.

Hereinafter, the second embodiment will be described. Compared to the first embodiment, the description of the same configuration is omitted, and the description of different configurations is described.

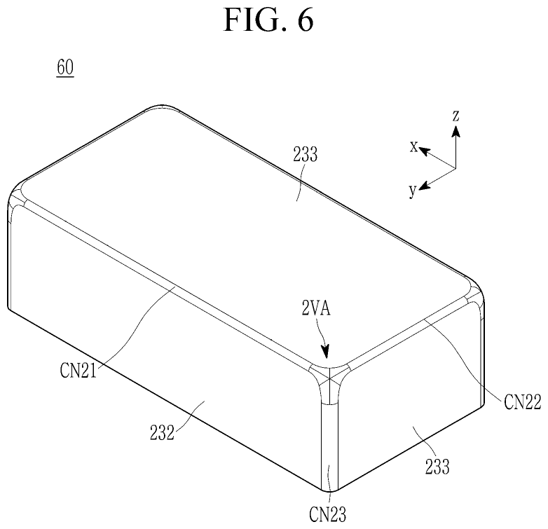

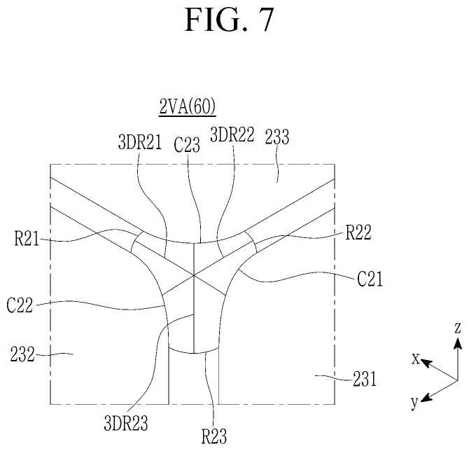

FIG. 6 is an inverted perspective view showing a reversed punch applied to a pouch forming device. FIG. 7 is a perspective view showing one vertex area in a punch of FIG. 6. Referring to FIG. 6 and FIG. 7, the punch 60 may include a first round R21, a second round R22, and a third round R23 to form one vertex area 2VA. The first round R21 may be convexly formed at the first corner CN21 in the first direction (the x-axis direction). The second round R22 may be convexly formed at the second corner CN22 in the second direction (the y axis direction) crossing the first direction. The third round R23 may be formed convexly at the third corner CN23 in the third direction (the z-axis direction) crossing the second direction.

Also, the punch 60 may include a first corner round C21, a second corner round C22, and a third corner round C23 to form one vertex area 2VA. The first corner round C21 may be formed as a round on the first side surface 231 corner corresponding to the first round R21 in the diagonal direction of the first corner CN21. The second corner round C22 may be formed as a round on the second side surface 232 corner corresponding to the second round R22 in the diagonal direction of the second corner CN22. The third corner round C23 may be formed as a round on the bottom 233 corner corresponding to the third round R23 in the diagonal direction of the second corner CN23.

The punch 60 of the second embodiment may include a first 3D round 3DR21, a second 3D round 3DR22, and a third 3D round 3DR23 to form one vertex area 2VA. The first 3D round 3DR21 may connect the center of the first corner round C21 at the center of the first round R21 in a convex 3D way. The second 3D round 3DR22 may connect the center of second corner round C22 at the center of second round R22 in a convex 3D way. The third 3D round 3DR23 may connect the center of the third corner round C23 in a convex 3D way at the center of the third round R23.

In the punch 60, the length of the first corner round C21 and the length of the second corner round C22 may be the same size (C21=C22). The length of the third corner round C23 may be smaller than the length of the first corner round C21 and the length of the second corner round C22 (C23<C21=C22).

Also, in the punch 60, the curvature radius of the first corner round C21 and the curvature radius of the second corner round C22 may be the same size (C21=C22). The curvature radius of the third corner round C23 may be smaller than the curvature radius of the first corner round C21 and the curvature radius of the second corner round C22 (C23<C21=C22). For convenience, no separate reference numeral is given for the length and the curvature radius.

Also, in the punch 60, the length of the first round R21 may be smaller than the length of the first corner round C21 (R21<C21). The length of the second round R22 may be smaller than the length of the second corner round C22 (R22<C22). The length of the third round R23 may be smaller than the length of the third corner round C23 (R23<C23).

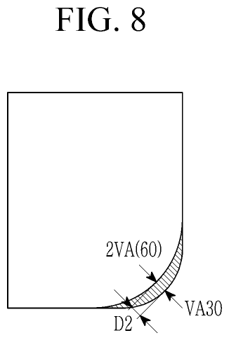

FIG. 8 is a top plan view showing space sizes for a vertex area in FIG. 7. Referring to FIG. 3, FIG. 7, and FIG. 8, the punch 30 of the first embodiment may include the first round R1 of 1.0 mm, the second round R2 of 1.0 mm, and the third round R3 of 1.5 mm, and may include the first 3D round 3DR1, the second 3D round 3DR2, and the third 3D round 3DR3. The punch 60 of the second embodiment may include the first round R21 of 0.5 mm, the second round R22 of 0.5 mm, and the third round R23 of 1.5 mm, and may include the first 3D round 3DR21, the second 3D round 3DR22, and the third 3D round 3DR23.

At this time, a difference D2 of 0.22 mm may be generated in the vertex areas 2VA and VA of the punches 60 and 30. In this regard, compared to the vertex area (VA) of the punch 30 of the first embodiment, the vertex area 2VA of the punch 60 of the second embodiment may secure a larger remaining thickness of the aluminum or aluminum sheet of the pouch 100, so cracks may be further prevented, and the formability may be further improved.

Referring to FIG. 4 and FIG. 7, even if the same first die round DR1 of 2.0 mm and second die round DR2 of 2.0 mm are applied to the punch 60 of the second embodiment and the punch 430 and the forming depth is set as 4.0 mm, the remaining thickness of 20.5 μm of aluminum or aluminum sheet in the vertex area 2VA of the second embodiment may be larger than the remaining thickness of 17.6 μm of aluminum or aluminum sheet in the vertex area 4VA.

In addition, even when the same first die round DR1 of 3.0 mm and second die round DR2 of 2.0 mm are applied to the punch 60 of the second embodiment and the punch 430 and the forming depth is set as 4.0 mm, the remaining thickness of 22.8 μm of aluminum or aluminum sheet in the vertex area (2VA) of the second embodiment may be larger than the remaining thickness of 17.6 μm of aluminum or aluminum sheet in the vertex area 4VA.

Compared to the case of the first die round DR1 of 2.0 mm and the second die round DR2 of 2 mm, the remaining thickness of aluminum or aluminum sheet in the vertex area 2VA may be larger in the case of the first die round DR1 of 3.0 mm and the second die round DR2 of 2 mm. Compared to the short corner SCN, increasing the die round in the long corner LCN may have a great effect on increasing the remaining thickness of aluminum or aluminum sheet in the vertex area 2VA.

FIG. 10 is a perspective view showing a rechargeable battery. FIG. 11 is an exploded perspective view showing a rechargeable battery of FIG. 10. Referring to FIG. 10 and FIG. 11, the rechargeable battery of the first embodiment may include a pouch 100 and a stack type electrode assembly 200 accommodated in the pouch 100.

The pouch 100 may be manufactured by forming a pouch sheet S as shown in FIG. 1. The pouch 100 may include an outer flange 150 and a forming part 160 provided on the outside. The pouch 100 may be integrally formed with the cover 110, but in the present embodiment, a configuration in which the pouch 100 and the cover 110 are formed separately is described as an example.

The electrode assembly 200 may include a separator 103, and a first plate 101 and a second plate 102 formed as single sheets on both sides of the separator 103. That is, the electrode assembly 200 has a structure in which the first plate 101 and the second plate 102 may be repeatedly disposed on both sides of the separator 103.

As an example, the first plate 101 may be a positive plate, and may include a positive active material layers 112 on both sides of the electrode current collecting plate 111. The electrode current collecting plate 111 may have an electrode tab 113 of an uncoated region protruded to one side. The electrode tab 113 may be directly drawn out to the outside of the pouch 100 or connected to a lead tab to be drawn out to the outside.

The second plate 102 may be a negative plate and may include a negative active material layer 122 on both sides of the electrode current collecting plate 121. The electrode current collecting plate 121 may have an electrode tab 123 of an uncoated region protruded to one side. The electrode tab 123 may be directly drawn out to the outside of the pouch 100 or connected to the lead tab to be drawn out to the outside of the pouch 100.

For example, the pouch base material S forming the pouch 100 and the cover 110 may be formed by including a polymer sheet 201 that forms the inner surface and may act as an electrical insulation and a thermal bonding, a nylon sheet 202 that forms the outer surface and acts as a protection, and an aluminum sheet 203 of providing a mechanical strength.

The forming part 160 of the pouch 100 may include side walls 161 and 162 connected to the outer flange 150, and a bottom 163 connected to the side walls 161 and 162 with the corner. The part that contributes to securing the thickness in the side walls 161 and 162, and the bottom 163 by the forming of the pouch base material S may be referred to as an aluminum sheet 203.

For convenience, for the constituent element of one vertex area VA of the punch 30 to be symmetrical to the constituent element of one vertex area PVA of the forming part 160, the same names are given, and the reference numerals are distinguished and assigned

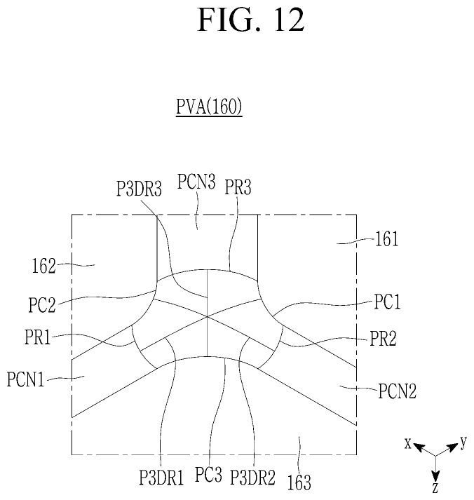

FIG. 12 is a perspective view showing one vertex area of a pouch. Referring to FIG. 11 and FIG. 12, the forming part 160 of the pouch 100 formed by the punch 30 of the first embodiment may include a first round PR1, a second round PR2, and a third round PR3 to form one vertex area PVA. The first round PR1 may be formed concavely at the first corner PCN1 in the second direction (the y-axis direction). The second round PR2 may be formed concavely at the second corner PCN2 in the first direction (the x-axis direction) crossing the second direction. The third round PR3 may be concavely formed at the third corner PCN3 in the third direction (the z-axis direction) crossing the first direction.

In addition, the forming part 160 of the pouch 100 may include a first corner round PC1, a second corner round PC2, and a third corner round PC3 to form one vertex area PVA. The first corner round PC1 may be formed as a round at first side wall 161 corner corresponding to the first round PR1 in the diagonal direction of the first corner PCN1. The second corner round PC2 may be formed as a round at second side wall 162 corner corresponding to the second round PR2 in the diagonal direction of. the second corner PCN2. The third corner round PC3 may be formed as a round at the bottom 163 corner corresponding to the third round PR3 in the diagonal direction of the third corner PCN3.

In addition, the forming part 160 of the pouch 100 may include a first 3D round P3DR1, a second 3D round P3DR2, and a third 3D round P3DR3 to form one vertex area PVA. The first 3D round P3DR1 may connect the center of the first corner round PC1 in a concave 3D way at the center of the first round PR1. The second 3D round P3DR2 may connect the center of second corner round PC2 in a concave 3D way at the center of the second round PR2. The third 3D round P3DR3 may connect the center of the third corner round PC3 in a concave 3D way at the center of the third round PR3.

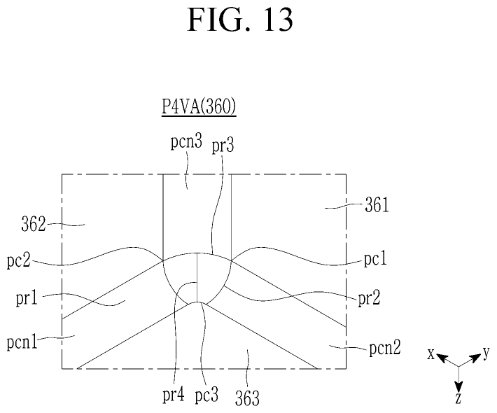

FIG. 13 is a perspective view showing another vertex area of a pouch. Referring to FIG. 13, the forming part 360 of the pouch can be applied to the pouch that accommodates the winding type electrode assembly.

For convenience, for the constituent element of one vertex area 4VA of the punch 430 to be symmetrical to the constituent element of one vertex area (P4VA) of the forming part 360, the same names are given and the reference numerals are separately assigned.

The forming part 360 may include a first round pr1, a second round pr2, a third round pr3, and a fourth round pr4 to form one vertex area P4VA. The first round pr1 may be formed concavely at the first corner pcn1 of the second direction (the y-axis direction). The second round pr2 may be concavely formed at the second corner pcn2 of the first direction (the x-axis direction) crossing the second direction. The third round pr3 may be concavely formed at the third corner pcn3 of the third direction (the z-axis direction) crossing the first direction. The fourth round pr4 may be concavely formed between the first round pr1 and the second round pr2, and may be set with the same size as the first round pr1 and the second round pr2.

In addition, the forming part 360 may include a first corner angle pc1, a second corner angle pc2, and a third corner round pc3 to form one vertex area P4VA. The first corner angle pc1 may be formed perpendicular to the first side wall 361 corner corresponding to the diagonal direction of the first corner pcn1 in the first round pr1. The second corner angle pc2 may be formed perpendicular to the second side wall 362 corner corresponding to the diagonal direction of the second corner pcn2 in the second round pr2. The third corner round pc3 may be formed as a round at the bottom 363 corner corresponding to the diagonal direction of the third corner pcn3 in the third round pr3.

Again, referring to FIG. 12 and FIG. 13, in the forming part 160 of the first embodiment, the curvature radius of the first corner round PC1, the curvature radius of the second corner round PC2, and the curvature radius of the third corner round PC3 may be formed larger than each curvature radius corresponding to the first corner round pc1, the second corner round pc2, and the third corner round pc3 in the pouch forming part 360 (PC1>pc1, PC2>pc2, PC3>pc3). The forming part 160 of the first embodiment may accommodate the electrode assembly of the stack type, and the pouch forming part 360 may accommodate the electrode assembly of the winding type.

In the forming part 160, the length of the first corner round PC1 and the length of the second corner round PC2 may be formed in the same size (PC1=PC2). The length of the third corner round PC3 may be larger than the length of the first corner round PC1 and the length of the second corner round PC2 (PC3>PC1=PC2).

Also, in the forming part 160, the curvature radius of the first corner round PC1 and the curvature radius of the second corner round PC2 may be the same size (PC1-PC2). The curvature radius of the third corner round PC3 may be larger than the curvature radius of the first corner round PC1 and the curvature radius of the second corner round PC2 (PC3>PC1=PC2). For convenience, no separate reference numerals are given for the length and the curvature radius.

Also, in the forming part 160, the length of the first round PR1 may be larger than the length of the first corner round PC1 (PR1>PC1). The length of the second round PR2 may be larger than the length of the second corner round PC2 (PR2>PC2). The length of the third round PR3 may be larger than the length of the third corner round PC3 (PR3>PC3).

Hereinafter, the second embodiment will be described. Compared to the first embodiment, the descriptions of the same configurations are omitted and descriptions of different configurations are described.

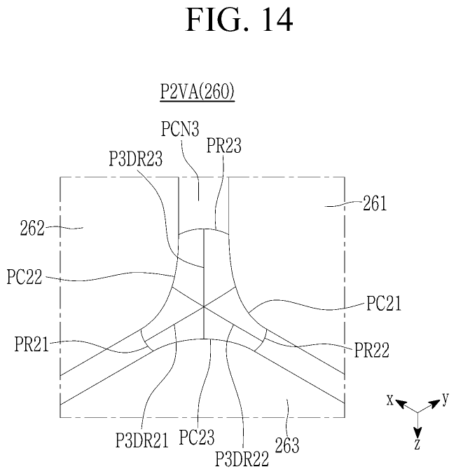

FIG. 14 is a perspective view showing another vertex area of a pouch. The forming part 260 of the pouch formed by the punch 60 of the second embodiment may include a first round PR21, a second round PR22, and a third round PR23 to form one vertex area P2VA. The first round PR21 may be concavely formed at the first corner PCN1 in the second direction (the y-axis direction). The second round PR22 may be concavely formed at the second corner PCN2 in the first direction (the x-axis direction) crossing the second direction. The third round PR23 may be concavely formed at the third corner PCN3 in the third direction (the z-axis direction) crossing the first direction.

In addition, the forming part 260 of the pouch may include a first corner round PC21, a second corner round PC22, and a third corner round PC23 to form one vertex area P2VA. The first corner round PC21 may be formed as a round at the first side wall 261 corner corresponding to the first round PR21 in the diagonal direction of the first corner PCN1. The second corner round PC22 may be formed as a round at the second side wall 262 corner corresponding to the second round PR22 in the diagonal direction of the second corner PCN2. The third corner round PC23 may be formed as a round at the bottom 263 corner corresponding to the third round PR23 in the diagonal direction of the third corner PCN3.

In addition, the forming part 260 of the pouch may include a first 3D round P3DR21, a second 3D round P3DR22, and a third 3D round P3DR23 to form one vertex area P2VA. The first 3D round P3DR21 may connect the center of the first corner round PC21 at the center of the first round PR21 in a concave 3D way. The second 3D round P3DR22 may connect the center of the second corner round PC22 at the center of the second round PR22 in concave 3D type. The third 3D round P3DR23 may connect the center of the third corner round PC23 in a concave 3D type at the center of the third round PR23.

In the forming part 260, the length of the first round PR21 may be smaller than the length of the first corner round PC21 (PR21<PC21). The length of the second round PR22 may be smaller than the length of the second corner round PC22 (PR22<PC22). The length of the third round PR23 may be smaller than the length of the third corner round PC23 (PR23<PC23).

Referring to FIG. 12, and FIG. 14, the forming part 160 of the pouch 100 of the first embodiment may include a first round PR1 of 1.0 mm, a second round PR2 of 1.0 mm, and a third round PR3 of 1.5 mm, and may include a first 3D round P3DR1, a second 3D round P3DR2, and a third 3D round P3DR3. The pouch forming part 260 of the second embodiment may include a first round PR21 of 0.5 mm, a second round PR22 of 0.5 mm, a third round PR23 of 1.5 mm, and may include a first 3D round P3DR21, a second 3D round P3DR22, and a third 3D round P3DR23.

At this time, a difference D2 of 0.22 mm may be generated in the vertex areas P2VA and PVA of the forming parts 160 and 260 (referring to FIG. 8). From this point of view, compared to the vertex area PVA of the first embodiment forming part 160, the vertex area P2VA of the forming part 260 of the second embodiment may secure a larger residual thickness of the aluminum or aluminum sheet of the pouch, so cracks may be further prevented, and the formability may be further improved.

Referring to FIG. 13 and FIG. 14, even when the same first die round DR1 of 2.0 mm and second die round DR2 of 2.0 mm are applied to the forming part 260 of the second embodiment and the forming part 360 the aluminum remaining thickness of 20.5 μm in the vertex area P2VA of the second embodiment may be larger than the aluminum remaining thickness of 17.6 μm in the vertex area P4VA.

In addition, even when the same first die round DR1 of 3.0 mm and second die round DR2 of 2.0 mm are applied to the forming part 260 of the second embodiment and the forming part 360 and the forming depth is set as 4.0 mm, the remaining thickness of 22.8 μm of aluminum or aluminum sheet in the vertex area P2VA of the second embodiment may be larger than the remaining thickness of 17.6 μm of aluminum or aluminum sheet in the vertex area P4VA.

Compared to the case of the first die round DR1 of 2.0 mm and the second die round DR2 of 2 mm, the remaining thickness of aluminum or aluminum sheet in the vertex area P2VA may be larger in the case of the first die round DR1 of 3.0 mm and the second die round DR2 of 2 mm. Compared to the short corner SCN, in the long corner LCN, increasing the die round may have a great effect on increasing the remaining thickness of aluminum or aluminum sheet in the vertex area P2VA.

By way of summation and review, a rechargeable battery may include an electrode assembly for charging and discharging, a pouch for accommodating the electrode assembly, and an electrode terminal electrically connecting the electrode assembly and drawing out to the outside of the pouch. The electrode assembly may include a winding type in which a negative plate and a positive plate are disposed on both sides with a separator therebetween and wound, and a stacking type in which a negative plate and a positive plate are stacked on both sides with a separator therebetween.

The rechargeable battery that accommodates the winding type electrode assembly in the pouch can accommodate an electrode assembly even if the corner portion of the pouch is molded into a relatively large round shape. However, the rechargeable battery accommodating the stack type electrode assembly in the pouch may require that the corner portion of the pouch be formed into a smaller round shape than the case in which the winding type electrode assembly is accommodated.

Due to the increasing in the capacity of the rechargeable battery and the decreasing in the thickness of a smartphone, the application of the stack type electrode assembly is required. However, even if in a case of simply performing a deep drawing with a punch, securing the thickness at the corner portion of the pouch may be insufficient. Because of this, since the pouch of the rechargeable battery is used in a set, for example, a battery module with structural weakness, a safety may be insufficient. A rechargeable battery that stably secures a thickness of a vertex area where side walls and a bottom of the pouch are connected to the corner even when the stack type electrode assembly is applied to a forming part of the pouch is disclosed. A rechargeable battery pouch forming device for forming the pouch of the rechargeable battery as described above is disclosed.

As such, in an embodiment, since the pouch base material may be formed by providing the first 3D round 3DR1, the second 3D round 3DR2, and the third 3D round 3DR3 in the vertex area of the punch, the pouch including the first 3D round P3DR1, the second 3D round P3DR2, and the third 3D round P3DR3 may be formed in the vertex area of the forming part.

Even when the stack type electrode assembly is applied, the first 3D round P3DR1, the second 3D round P3DR2, and the third 3D round P3DR3 may be provided in the side wall corner portion of the pouch and the vertex area where the side wall corner portion and the bottom may be connected, thereby the rechargeable battery of an embodiment may stably secure the thickness.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A rechargeable battery pouch forming device, comprising:
a die supporting a first surface of a pouch base material to form the pouch base material for a rechargeable battery having a first opening;
a stripper holding a second surface of the pouch base material supported on the die having a second opening larger than the first opening; and
a punch that descends from the second surface side of the pouch base material through the second opening and the first opening to form a pouch by forming the pouch base material, the punch comprising:
a first round at a first corner of a first direction to form a vertex area;
a second round at a second corner of a second direction crossing the first direction;
a third round at a third corner of a third direction crossing the second direction;
a first corner round curvedly shaped and at a first side corner corresponding to the first round in a diagonal direction of the first corner to form the vertex area;
a second corner round curvedly shaped and at a second side corner corresponding to the second round in a diagonal direction of the second corner, and
a third corner round curvedly shaped and at a bottom corner corresponding to the third round in a diagonal direction of the third corner, the vertex area comprising:
a first three dimensional round connecting the center of the first corner round in three dimensions at the center of the first round;
a second three dimensional round connecting the center of the second corner round in three dimensions at the center of the second round, and
a third three dimensional round connecting the center of the third corner round in three dimensions at the center of the third round.

2. The rechargeable battery pouch forming device as claimed in claim 1, wherein a first curvature radius of the first corner round, a second curvature radius of the second corner round, and a third curvature radius of the third corner round are larger than a fourth curvature radius of a first corner round, a fifth curvature radius of a second corner round, and a sixth curvature radius of a third corner round of the punch for an electrode assembly of a winding type to accommodate an electrode assembly of a stack type.

3. The rechargeable battery pouch forming device as claimed in claim 1, wherein:
the die has a long corner and a short corner that intersect corresponding to the first round and the second round of the punch at the second opening,
the long corner corresponds to the first corner of the punch and forms a first die round greater than the first round, and
the short corner corresponds to the second corner of the punch and forms a second die round greater than the second round.

4. The rechargeable battery pouch forming device as claimed in claim 1, wherein:
a first length of the first corner round and a second length of the second corner round are the same size, and
a third length of the third corner round is larger than the first length of the first corner round and the second length of the second corner round.

5. The rechargeable battery pouch forming device as claimed in claim 1, wherein:
a first curvature radius of the first corner round and a second curvature radius of the second corner round are the same size, and
a third curvature radius of the third corner round is larger than the first curvature radius of the first corner round and the second curvature radius of the second corner round.

6. The rechargeable battery pouch forming device as claimed in claim 1, wherein:
a first length of the first round is greater than a second length of the first corner round,
a third length of the second round is greater than a fourth length of the second corner round, and
a fifth length of the third round is greater than a sixth length of the third corner round.

7. The rechargeable battery pouch forming device as claimed in claim 1, wherein:
a first length of the first corner round and a second length of the second corner round are the same size, and
a third length of the third corner round is smaller than the first length of the first corner round and the second length of the second corner round.

8. The rechargeable battery pouch forming device as claimed in claim 1, wherein:
a first curvature radius of the first corner round and a second curvature radius of the second corner round are the same size, and
a third curvature radius of the third corner round is smaller than the first curvature radius of the first corner round and the second curvature radius of the second corner round.

9. The rechargeable battery pouch forming device as claimed in claim 1, wherein:
a first length of the first round is smaller than a second length of the first corner round,
a third length of the second round is less than a fourth length of the second corner round, and
a fifth length of the third round is smaller than a sixth length of the third corner round.

10. The rechargeable battery pouch forming device as claimed in claim 3, wherein a first curvature radius of the first die round has the same size as a second curvature radius of the second die round.

11. The rechargeable battery pouch forming device as claimed in claim 10, wherein the first curvature radius of the first die round, the second curvature radius of the second die round, and a third curvature radius of a third die round corresponding to the third round are larger than a fourth curvature radius of the first round, a fifth curvature radius of the second round, and a sixth curvature radius of the third round, respectively.

12. A rechargeable battery, comprising:
a pouch comprising an outer flange provided on an outside and a forming part within the outer flange; and
a stack type electrode assembly accommodated in the forming part, the forming part comprising:
side walls connected to the outer flange,
a bottom connected to the side walls with a corner,
first round at a first corner of a second direction to form a vertex area in the forming part;
a second round at a second corner of a first direction crossing the second direction, and
a third round at a third corner of a third direction crossing the first direction;
a first corner round curvedly shaped and at the first side wall corner corresponding to the first round in a diagonal direction of the first corner to form the vertex area;
a second corner round curvedly shaped and at the second side wall corner corresponding to the second round in a diagonal direction of the second corner, and
a third corner round curvedly shaped and at the bottom corner corresponding to the third round in a diagonal direction of the third corner, the vertex area comprising:
a first round connecting the center of the first corner round in a three dimensional type at the center of the first round;
a second three dimensional round connecting the center of the second corner round in a three dimensional type at the center of the second round; and
a third three dimensional round connecting the center of the third round at the center of the third corner round in a three dimensional type.

13. The rechargeable battery as claimed in claim 12, wherein a first curvature radius of the first corner round, a second curvature radius of the second corner round, and a third curvature radius of the third corner round are larger than a fourth curvature radius of a first corner round, a fifth curvature radius of a second corner round, and a sixth curvature radius of a third corner round of a pouch accommodating an electrode assembly of a winding type to accommodate an electrode assembly of a stack type.

14. The rechargeable battery as claimed in claim 12, wherein:
a first length of the first corner round and a second length of the second corner round are the same size, and
a third length of the third corner round is larger than the first length of the first corner round and the second length of the second corner round.

15. The rechargeable battery as claimed in claim 12, wherein:
a first curvature radius of the first corner round and a second curvature radius of the second corner round are the same size, and
a third curvature radius of the third corner round is larger than the first curvature radius of the first corner round and the second curvature radius of the second corner round.

16. The rechargeable battery as claimed in claim 12, wherein:
a first length of the first round is greater than a second length of the first corner round,
a third length of the second round is greater than a fourth length of the second corner round, and
a fifth length of the third round is larger than a sixth length of the third corner round.

17. The rechargeable battery as claimed in claim 12, wherein:
a first length of the first corner round and a second length of the second corner round are the same size, and
a third length of the third corner round is smaller than the first length of the first corner round and the second length of the second corner round.

18. The rechargeable battery as claimed in claim 12, wherein:
a first curvature radius of the first corner round and a second curvature radius of the second corner round are the same size, and
a third curvature radius of the third corner round is smaller than the first curvature radius of the first corner round and the second curvature radius of the second corner round.

19. The rechargeable battery as claimed in claim 12, wherein:
a first length of the first round is smaller than a second length of the first corner round,
a third length of the second round is smaller than a fourth length of the second corner round, and
a fifth length of the third round is smaller than a sixth length of the third corner round.

20. A rechargeable battery pouch forming device, comprising:
a die supporting a first surface of a pouch base material to form the pouch base material for a rechargeable battery having a first opening;
a stripper holding a second surface of the pouch base material supported on the die having a second opening larger than the first opening; and
a punch that descends from the second surface side of the pouch base material through the second opening and the first opening to form a pouch by forming the pouch base material, the punch comprising:
a first round formed at a first corner of a first direction to form a vertex area;
a second round formed at a second corner of a second direction crossing the first direction;
a third round formed at a third corner of a third direction crossing the second direction;
a first corner round curvedly shaped and at a first side corner corresponding to the first round in a diagonal direction of the first corner to form the vertex area;
a second corner round curvedly shaped and at a second side corner corresponding to the second round in a diagonal direction of the second corner, and
a third corner round curvedly shaped and at a bottom corner corresponding to the third round in a diagonal direction of the third corner.
